(19) United States
(12) Patent Application Publication
(10) Pub. No.: US 2025/0005386 A1
(43) Pub. Date: Jan. 2, 2025

(54) SYSTEMS AND METHODS FOR AUTOMATED LABEL MODEL SELECTION

(71) Applicant: Capital One Services, LLC, McLean, VA (US)

(72) Inventors: Taylor TURNER, Richmond, VA (US); Jeremy GOODSITT, Champaign, IL (US); Michael DAVIS, Arlington, VA (US); Kenny BEAN, Herndon, VA (US); Tyler FARNAN, San Diego, CA (US)

(73) Assignee: Capital One Services, LLC, McLean, VA (US)

(21) Appl. No.: 18/345,942

(22) Filed: Jun. 30, 2023

(51) Int. Cl. G06N 5/022; G06N 20/00

(52) U.S. Cl. CPC G06N 5/022; G06N 20/00

(57) ABSTRACT

Systems and methods are described herein for increasing the efficiency of generating training data. Specifically, the systems and methods relate to increasing the efficiency and accuracy of data labeling, particularly in instances of dynamically updated datasets of unlabeled data. For example, many applications of artificial intelligence models require real-time processing in order to generate usable results, which itself creates a technical hurdle. To further exacerbate this problem, many of the artificial intelligence models that provide this real-time processing require real-time or near-real-time training as new data is received in order to maintain their accuracy. These processing requirements create fundamental challenges in generating training data in instances of dynamically updated datasets of unlabeled data.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be tedious and laborious. These technical problems may present an inherent problem with attempting to use an artificial intelligence-based solution in data labeling for dynamically updated datasets of unlabeled data.

### SUMMARY

Systems and methods are described herein for increasing the efficiency of generating training data. Specifically, the systems and methods relate to increasing the efficiency and accuracy of data labeling, particularly in instances of dynamically updated datasets of unlabeled data. For example, many applications of artificial intelligence models require real-time processing in order to generate usable results, which itself creates a technical hurdle. To further exacerbate this problem, many of the artificial intelligence models that provide this real-time processing require real-time or near-real-time training as new data is received in order to maintain their accuracy. These processing requirements create fundamental challenges in generating training data in instances of dynamically updated datasets of unlabeled data.

Existing systems have difficulty in adapting artificial intelligence models for improving the efficiency and accuracy in determining the appropriate model to label dynamically updated datasets of unlabeled data and face several technical challenges such as a reliance on large amounts of high-quality data. For example, the process of obtaining this data and ensuring it is high-quality can be complex and time-consuming. Additionally, data that is obtained may need to be categorized and labeled accurately, which can be difficult, time-consuming, and a manual task.

To overcome these technical deficiencies in adapting artificial intelligence models for this practical benefit, methods and systems disclosed herein may increase the efficiency and accuracy of labeling unlabeled dataset by bifurcating model selection and model processing. In particular, the system may use an initial model to identify attributes in a dataset and then selects a second model based on the efficiency of processing the identified attributes. Conventionally, such a bifurcation would only increase the length of time needed to process data and thus only exacerbate the technical problem in real-time processing. However, the system may overcome this technical problem by selecting a sublinear algorithm. For example, a sublinear algorithm is an algorithm whose execution time (or processing rate), f (n), grows slower than the size of the dataset, n.

However, the use of a sublinear algorithm also creates a novel technical problem in that sublinear algorithms only give a probability of a correct prediction. The systems and methods account for this by comparing the accuracy of any sublinear algorithm against a threshold accuracy metric. The system may then select a data labeling model based on this threshold accuracy being met. If the threshold accuracy is met, the system may generate a labeled dataset based on the selected data labeling model. Accordingly, the methods and systems provide the practical benefit of improving the efficiency and accuracy in determining the appropriate model from a library of trained models to label dynamically updated datasets of unlabeled data.

In some aspects, methods and systems are designed to increase accuracy when labeling unlabeled datasets by bifurcating attribute selection and model processing. The method may receive a first dataset of unlabeled data, wherein the first dataset has a growth rate. The method may determine, using an attribute selection model, a first set of attributes in the first dataset. The method may determine, based on the first set of attributes, a first processing rate for a first data labeling model of a plurality of data labeling models, wherein the first processing rate is a function of a size of the first dataset. The method may determine that the first processing rate is lower than the growth rate. The method may select, based on determining that the first processing rate is lower than the growth rate, the first data labeling model from the plurality of data labeling models. The method may determine a first predicted accuracy metric for the first data labeling model. The method may compare the first predicted accuracy metric to a threshold data labeling accuracy metric. The method may in response to determining that the first predicted accuracy metric corresponds to the threshold data labeling accuracy metric, determine to use the first data labeling model to label the first dataset. The method may generate for display, on a user interface, a first labeled dataset corresponding to the first dataset using the first data labeling model.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for improving the efficiency and accuracy in determining the appropriate model to label dynamically updated datasets of unlabeled data, in accordance with one or more embodiments.

FIG. 2 shows an illustrative diagram for performing model processing by generating a labeled dataset based on the selected data labeling model from the model selection, in accordance with one or more embodiments.

FIG. 3 shows illustrative components for a system used to increase efficiency and accuracy when labeling an unlabeled dataset by bifurcating model selection and model processing, in accordance with one or more embodiments.

FIG. 4 shows a flowchart of the steps involved in increasing efficiency and accuracy when labeling an unlabeled dataset by bifurcating model selection and model processing, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

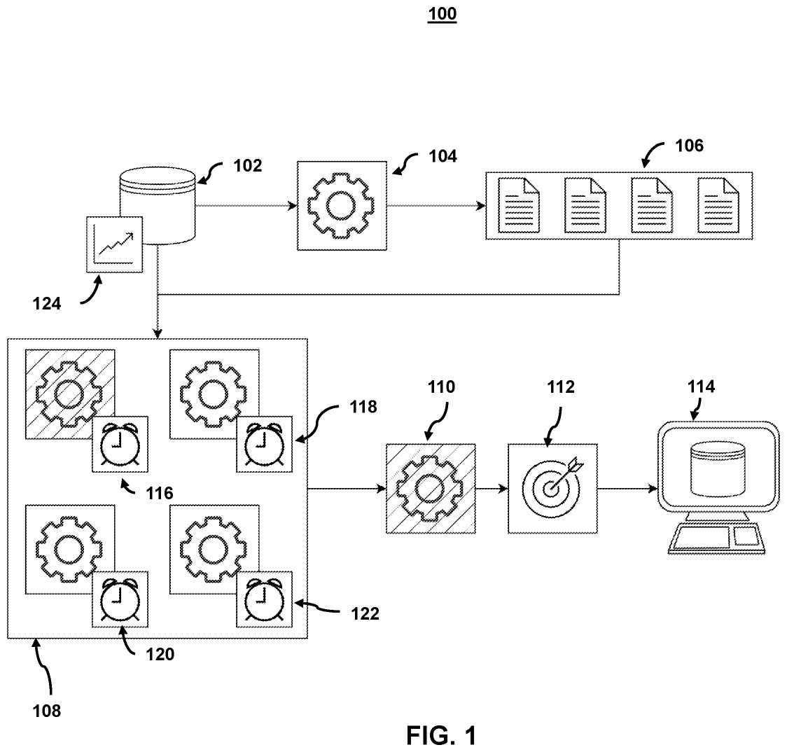

FIG. 1 shows an illustrative diagram for improving the efficiency and accuracy in determining the appropriate model to label dynamically updated datasets of unlabeled data, in accordance with one or more embodiments. For example, system 100 bifurcates model selection and model processing by using two models (e.g., attribute identification model 104 and a data labeling model from plurality of data labeling models 108). System 100 may include a model attribute identification model (e.g., attribute identification model 104) that is used to select a data labeling model (e.g., data labeling model 110) based on the efficiency in processing identified attributes (e.g., attributes 106) in data points from a dataset (e.g., dataset 102). The system may maintain processing efficiency despite the bifurcation in model selection and processing by taking into consideration the processing rate of data labeling models (e.g., processing rate 116, processing rate 118, processing rate 120, and processing rate 122).

System 100 may select a data labeling model (e.g., data labeling model 110) based on determining that the processing rate associated with the data labeling model (e.g., processing rate 116) is lower than the growth rate of the dataset (e.g., growth rate 124). System 100 may also determine a predicted accuracy metric associated with the selected data labeling model (e.g., predicted accuracy metric 112 associated with data labeling model 110). The system may compare the predicted accuracy metric (e.g., predicted accuracy metric 112) with a threshold data labeling accuracy metric, and upon determining that the predicted accuracy metric corresponds to the threshold data labeling accuracy metric, the system may use the selected data labeling model (e.g., data labeling model 110) to generate a labeled dataset corresponding to the unlabeled dataset. For example, the system may generate labeled dataset 114 which corresponds to dataset 102.

The system may be used to identify a model to label a dataset of unlabeled data. In disclosed embodiments, a dataset of unlabeled data may include a set of data without any associated identifiers used to classify, categorize or describe the respective data. In some embodiments, the dataset of unlabeled data (e.g., dataset 102) may comprise an unlabeled set of strings in a natural language processing application. In some embodiments, the dataset of unlabeled data (e.g., dataset 102) may comprise an unlabeled dataset of image files in an image processing application.

The system may be used to determine attributes in a dataset. In disclosed embodiments, attributes may include a descriptor for a data point or data object that may represent the characteristics or features of the data object. For example, in the context of image processing applications, attributes associated with a dataset (e.g., attributes 106 associated with dataset 102) may include information such as colors, shapes, or textures. In the context of natural language processing applications, attributes associated with a dataset may include information such as words, tone, or length.

The system may be used to identify attributes in a dataset using an attribute selection model. In disclosed embodiments, an attribute selection model may include one or more algorithms that identify particular attributes in the dataset. For example, in a dataset associated with a natural language processing application, the model may identify attributes corresponding to a string (e.g., part-of-speech, or named entities). For example, in a dataset associated with an image processing application, the model may identify attributes corresponding to local features in an image (e.g., corners, blobs, edges, or points of interest).

For example, an attribute selection model (e.g., attribute identification model 104), associated with an unlabeled dataset (e.g., dataset 102), may comprise algorithms to identify relevant attributes in a dataset (e.g., identifying attributes for natural language processing or image recognition applications). The attribute selection model may be used to identify one or more attributes associated with the dataset (e.g., attributes 106).

The system may be used to select a data labeling model to label a dataset. In disclosed embodiments, a label may be assigned to data in a dataset. The label assigned to a piece of data in the dataset may explain what the piece of data is. For example, if the piece of data is an image, the label may indicate that the piece of data is a person or a tree. As another example, the label may correspond to a text value, a bank account number, a credit card, an email address, a hash value, an IPV4 address, an IPV6 address, a MAC address, a person, a phone number, a social security number, a URL, a date, a time, an integer, a float, or an ordinal in a dataset. For example, if the piece of data is an audio recording, the label may correspond to words being said. In some embodiments, the labels can be used to categorize data. For example, in a self-driving environment, labels can allow the system to categorize people, bikes, cars, or lanes. In some embodiments, the labels can be used to develop a regression model. Specifically, the labels can be used to guide the model's learning process.

The system may be used to determine attributes that have a corresponding attribute type. In disclosed embodiments, an attribute type may refer to the type of data points stored in a dataset. For example, an attribute type may be a number, text string, or image. The attribute type may be associated with more or less accurate labels (e.g., an attribute type indicating the number of distinct entries typically has high accuracy, whereas an attribute type indicating the number of people can be lower accuracy). As such, the attribute type may influence the threshold data labeling accuracy. In some embodiments, the attribute type may be based on a data profile. The data profile may be a dictionary containing statistics and predictions about the dataset (e.g., the number of columns contained in the input dataset, the format of the file containing the input dataset, the standard deviation of all entries in the sample, or the number of distinct entries in the sample). In some embodiments, the attribute type (e.g., data profiles) can be used as a mechanism for determining the data labeling model based on desired output intent and the data incoming.

The system may be used to determine attributes based on labeling requirements. In disclosed embodiments, labeling requirements may include requirements that must be adhered to when determining the data labeling model to label the dataset. For example, labeling requirements may include requirements for accuracy, completeness, or granularity based on the application. For example, if the dataset corresponds to an imaging processing application, the labeling requirements may include a requirement for accurate image labeling, a requirement that all the images should be labeled, or a requirement that more details should be given based on the image and context (e.g., an image processing application required to determine the make and model of a car as opposed to just a car). The labeling requirements may be used to determine attributes in the dataset that are relevant to the application.

The system may be used to select a data labeling model to label an unlabeled dataset. In disclosed embodiments, a data labeling model may include a model used to label data in a dataset for use in a machine learning algorithm. For example, the data labeling model may be used during preprocessing when developing a machine learning model. The data labeling model may be used to generate training data in instances of dynamically updated datasets of unlabeled data (e.g., dataset 102).

In some embodiments, the data labeling model may comprise predetermined labels. In some embodiments, predetermined labels may comprise a set of categories that have been defined to categorize data in a dataset pertaining to a specific application. For example, predetermined labels for a natural language processing application may include tone labels (e.g., positive, negative, or neutral).

In some embodiments, the attribute identification model may identify attributes based on a labeling category. For example, in an image processing application, attribute identification model 104 may use labeling categories such as “person” or “vehicle.” For example, in a natural language processing application, the system may use labeling categories such as “positive,” “neutral” or “negative” to identify attributes that may influence labeling decisions while filtering out unrelated attributes.

The system may be used to determine a predicted accuracy metric associated with a data labeling model. In disclosed embodiments, a predicted accuracy metric may comprise a metric that measures how well the labeling model is expected to perform based on the attributes and growth rate of a dataset. The predicted accuracy metric may be used to ensure the model used to label the dataset is likely to be the best accuracy data labeling model (e.g., predicted accuracy metric 112 corresponding to data labeling model 110) based on attributes associated with a dataset (e.g., attributes 106 associated with dataset 102). The predicted accuracy metric may correspond to how accurate the applied labels are given the attributes associated with the dataset (e.g., attributes 106 associated with dataset 102). The predicted accuracy metric may be compared to a threshold data labeling accuracy metric to determine that the data labeling model is the best accuracy data labeling model for the dataset.

The system may be used to determine a processing rate for a data labeling model. In disclosed embodiments, a processing rate may include the speed at which the data labeling model can label incoming data (e.g., processing rate 116 which represents how fast data labeling model 110 can label incoming data). The processing rate may be measured in terms of the amount of data labeled per unit of time. For example, the processing rate for images in a database associated with an image processing application may comprise the number of images labeled per minute. This can help determine the efficiency of a model.

The system may be used to identify a growth rate in a dataset. In disclosed embodiments, a growth rate may include the rate at which additional data is added to a dataset. For example, a growth rate for a dataset (e.g., growth rate 124 for dataset 102) may observe an increase in data added to the dataset over time. For example, if a dataset associated with an image processing application contains 100 initial images and 20 images are added, then the dataset associated with the image recognition application would have a growth rate of 20%. The growth rate of the dataset (e.g., growth rate 124) may be compared to the processing rate (e.g., processing rate 116, processing rate 118, processing rate 120, or processing rate 122). For example, if a data labeling model has a processing rate that is lower than the growth rate of the dataset, then the system may select the data labeling model from a plurality of data labeling models to consider for labeling the dataset. If the data labeling model has a processing rate that is lower than the growth rate, it may be a sublinear algorithm. The system may prefer a sublinear algorithm to ensure that the length of time needed to process data is minimized, thereby increasing labeling efficiency.

The system may be used to generate a labeled dataset using a best accuracy data labeling model. In disclosed embodiments, a labeled dataset may include a dataset comprising data points that have been assigned a label corresponding to the application and attributes corresponding to the dataset. For example, a labeled dataset that is used for natural language processing may assign labels to data points that indicate tone (e.g., labeled dataset 114). For example, a labeled dataset that is used for image processing may assign labels to data points that indicate the type of object in a picture (e.g., labeled dataset 114).

In some embodiments, the best accuracy data labeling model can be selected from a plurality of available pre-trained machine learning models. For example, the best accuracy data labeling model may be a model that is part of a repository of pre-trained machine learning models. The repository of pre-trained models can be hosted online or locally. The repository of pre-trained models can be referred to as a model zoo.

In some embodiments, the model zoo may contain models that offer pre-trained models that can complete a variety of tasks such as image classification, natural language processing, and object detection. By identifying the best accuracy data labeling model from the model zoo, the system makes it possible for applications with limited data or computational resources to have access to models without the data-intensive and computation-intensive training process.

Furthermore, using a model zoo has distinct benefits over using another approach for automatic labeling. For example, other approaches often correspond to lower accuracy due to smaller datasets used when training versus model zoos which often have pre-trained models that have been trained using large datasets. For example, using other approaches often correspond to high specificity as they may be developed for a single use case versus a model in a model zoo that is often developed for multiple use cases and thus can typically accept more generic inputs. As another example, using other approaches often corresponds to slower labeling abilities as the model may not be pre-trained versus a model zoo, where the models are pre-trained.

The system may present a labeled dataset to a user on a user interface. In disclosed embodiments, a user interface may comprise a human-computer interaction and communication in a device, and may include display screens, keyboards, a mouse, and the appearance of a desktop. For example, a user interface may comprise a way a user interacts with an application or a website.

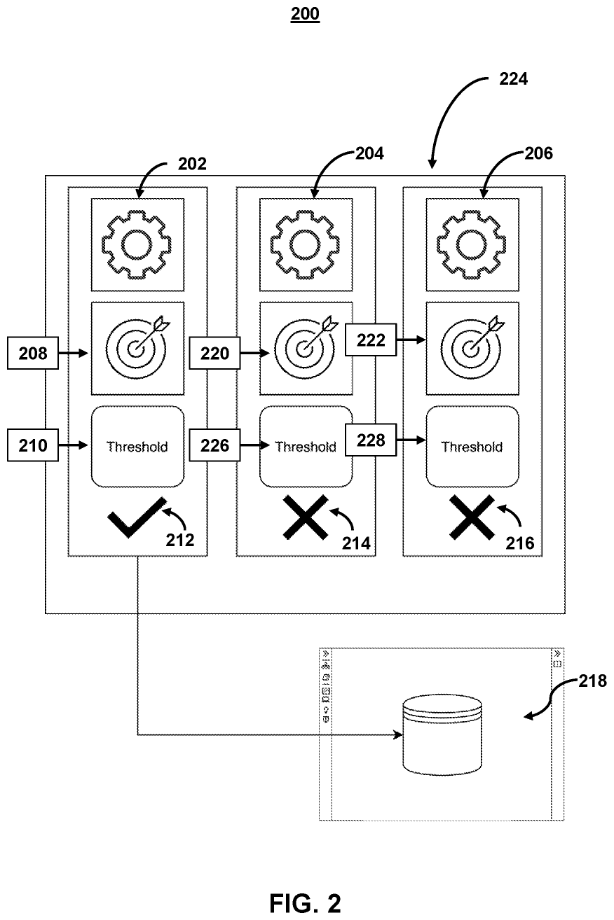

FIG. 2 shows an illustrative diagram for model processing by generating a labeled dataset based on the selected data labeling model from the model selection, in accordance with one or more embodiments. For example, system 200 may include plurality of data labeling models 224 (which may represent plurality of data labeling models 108 (FIG. 1)). Plurality of data labeling models 224 may include data labeling model 202, data labeling model 204, and data labeling model 206. For example, a data labeling model may include a predicted accuracy metric (e.g., predicted accuracy metric 208, predicted accuracy metric 220, or predicted accuracy metric 222). A data labeling model may also include a threshold accuracy metric (e.g., threshold accuracy metric 210, threshold accuracy metric 226, or threshold accuracy metric 228). For example, the predicted accuracy metric may be used to compare to a threshold data labeling accuracy metric to determine which data labeling model to use to label the dataset.

Based on if the predicted accuracy metric corresponding to the data labeling model corresponds to the threshold accuracy metric, the system will make a determination (e.g., selection determination 212, rejection determination 214, or rejection determination 216) to use the corresponding data labeling model (e.g., data labeling model 202, data labeling model 204, or data labeling model 206). For example, predicted accuracy metric 208 may correspond to threshold accuracy metric 210. Thus, the system may make selection determination 212 and use data labeling model 202 to label the dataset (e.g., dataset 102 (FIG. 1)). The labeled dataset (e.g., labeled dataset 218) may be presented to the user on a user interface.

The system may use a threshold data labeling accuracy metric associated with a data labeling model to compare data labeling models to use for a given dataset. In disclosed embodiments, a threshold data labeling accuracy metric may comprise a measure of how well the model can label a dataset based on a comparison between the predicted labels and the actual labels for a dataset.

In some embodiments, the system may determine the threshold data labeling accuracy metric by establishing a threshold based on the data labeling accuracy metric. For example, the system may determine the threshold data labeling accuracy metric by determining the necessary number of labels attributed to data points in the dataset that are correct versus incorrect. In applications where a determination is critical the threshold data labeling accuracy metric may be higher than in applications where the determination is not critical. By determining the threshold data labeling accuracy, the system may better determine which data labeling model to use to label a dataset.

The system may be used to determine a predicted accuracy metric associated with a data labeling model. In disclosed embodiments, a predicted accuracy metric may comprise a metric that measures how well the labeling model is expected to perform based on the attributes and growth rate of a dataset. In some embodiments, the predicted accuracy metric may be used to ensure the model used to label the dataset is likely to be the best accuracy data labeling model (e.g., predicted accuracy metric 112 corresponding to data labeling model 110, predicted accuracy metric 208 corresponding to data labeling model 202, predicted accuracy metric 220 corresponding to data labeling model 204, or predicted accuracy metric 222 corresponding to data labeling model 206) based on attributes associated with a dataset. The predicted accuracy metric may correspond to how accurate the applied labels are given the attributes associated with the dataset.

In some embodiments, the system may determine the predicted accuracy metric by splitting the data from the dataset into a training set and a testing set, using the data labeling model to train the training set, and determine the accuracy based on using the model for the testing set. For example, by determining the predicted accuracy metric, the system may compare the predicted accuracy metric to the threshold data labeling accuracy metric to determine that the data labeling model is the best accuracy data labeling model for the dataset. If the predicted accuracy metric meets or exceeds the threshold data labeling accuracy metric, then the data labeling model may be the best accuracy data labeling model for the dataset (e.g., data labeling model 110 or data labeling model 202).

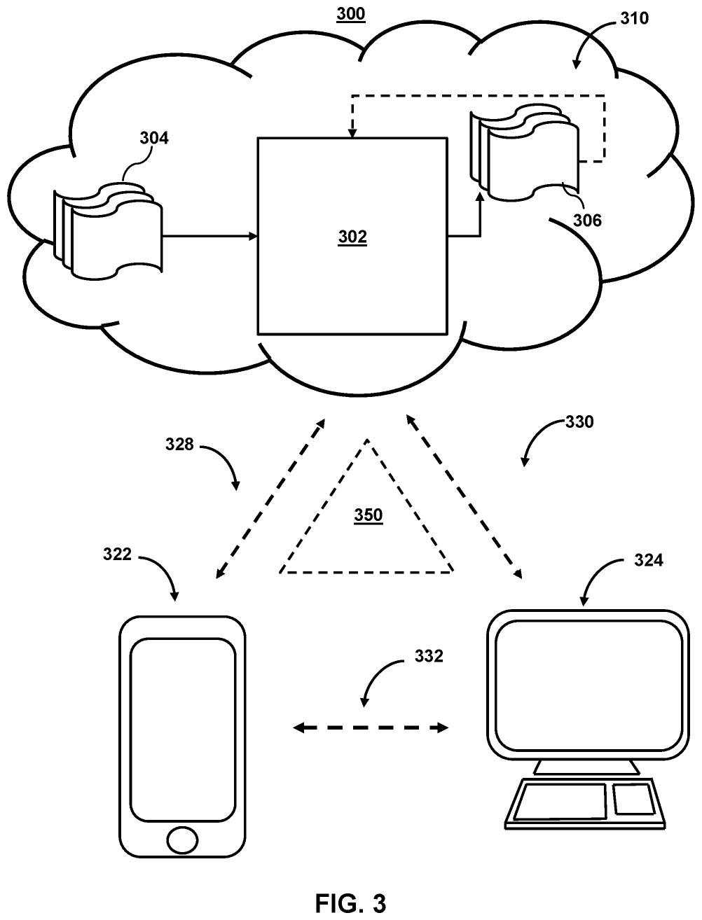

FIG. 3 shows illustrative components for a system used to increase efficiency and accuracy when labeling an unlabeled dataset by bifurcating model selection and model processing, in accordance with one or more embodiments. For example, FIG. 3 may show illustrative components for generating training data in instances of dynamically updated datasets of unlabeled data. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include dataset 102, attribute identification model 104, or plurality of data labeling models 108. Additionally, cloud components 310 may include data labeling model 202, data labeling model 204, or data labeling model 206. Cloud components 310 may access dataset 102 and attributes associated with dataset 102 such as growth rate 124 or attributes 106.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., whether or not a data labeling model is the best accuracy model for a given dataset).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., whether or not the outputted data labeling model is a high-accuracy model or low-accuracy model for a given inputted dataset).

In some embodiments, the model (e.g., model 302) may automatically perform actions based on outputs 306. In some embodiments, the model (e.g., model 302) may not perform any actions. The output of the model (e.g., model 302) may be used to identify the best accuracy model for a given inputted dataset from a plurality of data models and generate the labeled dataset using the best accuracy model.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDOS protection, and API layer 350 may use RESTful APIs as standard for external integration.

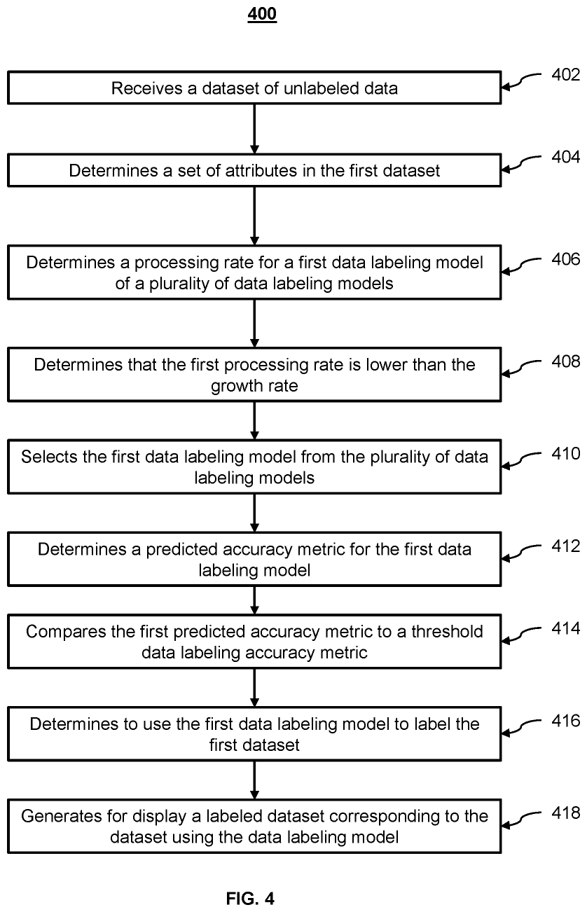

FIG. 4 shows a flowchart of the steps involved in increasing efficiency and accuracy when labeling an unlabeled dataset by bifurcating model selection and model processing, in accordance with one or more embodiments. For example, the system may use process 400 (e.g., as implemented on one or more system components described above) in order to improve the efficiency and accuracy in determining the appropriate model to label dynamically updated datasets of unlabeled data.

At step 402, process 400 (e.g., using one or more components described above) receives a dataset of unlabeled data. For example, the system may receive a first dataset of unlabeled data, wherein the first dataset has a growth rate. For example, the system may receive a first dataset that comprises unlabeled data. By receiving a dataset of unlabeled data, the system may be able to identify relevant attributes in order to increase efficiency and accuracy in labeling by bifurcating model selection and model processing. Specifically, the system may be able to identify attributes in the unlabeled dataset during model selection.

At step 404, process 400 (e.g., using one or more components described above) determines a set of attributes in the first dataset. For example, the system may determine, using an attribute selection model, a first set of attributes in the first dataset. For example, the system may apply a first model that identifies particular attributes in the dataset. The system may use one or more algorithms that identify specific attributes in the dataset. By doing so, the system may identify particular attributes that may be used to predict how accurate different labeling models may be when used to label unlabeled data in the dataset. By determining a set of attributes in the first dataset, the system may be able to select the best accuracy data labeling model for a dataset based on the set of attributes, thereby increasing efficiency and accuracy in labeling.

In some embodiments, the system may identify specific sets of attributes based on one or more criteria. For example, the system may determine the first set of attributes in the first dataset by determining an application type for an application using the first dataset, and filtering, based on the application type, a plurality of attributes in the first dataset to generate the first set of attributes. For example, if an application is using a dataset to make natural language processing recommendations, the system may identify a set of attributes based on keywords (e.g., characteristics of the data that are likely to influence any labeling decisions). By identifying specific sets of attributes based on application type, the system may identify the best accuracy model that is tailored to a specific use case such as natural language processing or image processing, thereby increasing the accuracy of labeling.

In some embodiments, the system may identify specific sets of attributes based on one or more criteria. For example, the system may determine the first set of attributes in the first dataset by determining a labeling category for the first dataset, and filtering, based on the labeling category, a plurality of attributes in the first dataset to generate the first set of attributes. For example, the system may determine a labeling category to which labels for the dataset may correspond. As such, the system may identify particular attributes that may influence those labeling decisions, while filtering out other attributes. By identifying specific sets of attributes based on a labeling category, the system may increase labeling consistency, organization, and speed.

In some embodiments, the system may select a particular model based on the characteristics of the dataset. For example, the system may determine the first set of attributes in the first dataset by determining a size of the first dataset, and selecting, based on the size, the first attribute selection model from a plurality of attribute selection models. For example, each model may process data differently, and the system may therefore select a model that is most effective in identifying attributes in datasets based on the characteristics of the datasets. Additionally or alternatively, the system may use other criteria for selecting a model. For example, the system may need to process a dataset in real-time or in near real-time. As such, the system may need to select a model that can achieve near real-time processing and/or near-real-time processing of a dataset having a given size. By selecting a particular model based on the characteristics of the dataset, the system may refine the selection process and increase the likelihood that the selected model is the best accuracy model for the corresponding dataset, thereby increasing the accuracy of labeling.

In some embodiments, the system may select a model based on a required processing rate. For example, the system may determine the first set of attributes in the first dataset by determining a required processing rate of the first dataset, and selecting, based on the required processing rate, the first attribute selection model from a plurality of attribute selection models. For example, different algorithms may process data at different rates. Accordingly, the system may select a model based on how quickly the model may process the data (or how much data needs to be processed). By selecting a model based on a required processing rate, the system may refine the selection process and increase the likelihood that the selected model is the best accuracy model to label the corresponding dataset, thereby increasing the accuracy of labeling.

In some embodiments, the system may use one or more models that identify specific attributes in the dataset. For example, the system may determine the first set of attributes in the first dataset by determining a second processing rate for the attribute selection model, determining that the second processing rate is lower than the growth rate, and selecting, based on determining that the second processing rate is lower than the growth rate, the attribute selection model. In some embodiments, the system may use a sublinear algorithm for the attribute selection model. For example, a sublinear algorithm is an algorithm whose execution time (or processing rate), f (n), grows slower than the size of the problem, n, but only gives an approximate or probability of a correct answer. By using one or more models that identify specific attributes in the dataset, the system may identify additional attributes to use or confirm identified attributes, thereby increasing accuracy.

In some embodiments, the system may determine attributes by comparing the second predicted accuracy metric to a threshold attribute selection accuracy metric. For example, the system may determine the first set of attributes in the first dataset by determining a second predicted accuracy metric for the attribute selection model, comparing the second predicted accuracy metric to a threshold attribute selection accuracy metric, and in response to determining that the second predicted accuracy metric corresponds to the threshold attribute selection accuracy metric, determining to use the attribute selection model to determine the first set of attributes in the first dataset. For example, similar to the selection of a data labeling model, the system may also verify that any potential attribute selection model has a threshold level of accuracy. By determining attributes by comparing the second predicted accuracy metric to a threshold attribute selection accuracy metric, the system may ensure that selected attributes are accurate which may lead to improvements in accuracy and efficiency in selecting a data labeling model.

At step 406, process 400 (e.g., using one or more components described above) determines a processing rate for a first data labeling model of a plurality of data labeling models. For example, the system may determine, based on the first set of attributes, a first processing rate for a first data labeling model of a plurality of data labeling models, wherein the first processing rate is a function of a size of the first dataset. For example, the system may determine how quickly a first data labeling model may process incoming data. By determining a processing rate for a first data labeling model of a plurality of data labeling models, the system may be able to filter inefficient or non-applicable data labeling models depending on the processing rate, thereby improving the accuracy and efficiency of the data labeling model.

At step 408, process 400 (e.g., using one or more components described above) determines that the first processing rate is lower than the growth rate. For example, the system may determine that the first processing rate is lower than the growth rate. For example, the system may determine whether the first data labeling model may process data in the dataset faster than (or at least equal to) the rate at which the dataset is being updated. By determining that the first processing rate is lower than the growth rate, the system may improve the efficiency and accuracy of labeling the dataset.

At step 410, process 400 (e.g., using one or more components described above) selects the first data labeling model from the plurality of data labeling models. For example, the system may select, based on determining that the first processing rate is lower than the growth rate, the first data labeling model from the plurality of data labeling models. For example, the system may select a data labeling model to label a dataset after determining that it is the best accuracy data labeling model. For example, the system may select a data labeling model that efficiently identifies pictures in an image processing application or a data labeling model that efficiently identifies parts of speech in a natural language processing application. By selecting the first data labeling model from the plurality of data labeling models, the system may increase the likelihood that the dataset is labeled efficiently and accurately.

At step 412, process 400 (e.g., using one or more components described above) determines a predicted accuracy metric for the first data labeling model. For example, the system may determine a first predicted accuracy metric for the first data labeling model. For example, the system may determine a predicted accuracy metric corresponding to a data labeling model used in a natural language processing application or image processing application. The predicted accuracy metric may be determined by predicting, based on past performance or a subset of the dataset, how many of the images or strings are correctly labeled. By determining a predicted accuracy metric for the first data labeling model, the system may increase the likelihood that the best accuracy data labeling model is used to label the dataset, thereby maximizing accuracy when labeling the dataset.

In some embodiments, the system may generate an actual accuracy metric based on comparing the second labeled dataset to the known labels of the previous version of the first dataset. For example, the system may determine the first predicted accuracy metric for the first data labeling model by retrieving a second labeled dataset, wherein the second labeled dataset corresponds to a previous version of the first dataset that was labeled using the first data labeling model, comparing the second labeled dataset to known labels of the previous version of the first dataset, and generating an actual accuracy metric based on comparing the second labeled dataset to the known labels of the previous version of the first dataset, wherein the first predicted accuracy metric is based on the actual accuracy metric. In some embodiments, the system may periodically test the accuracy of labeled datasets. The system may do so by generating known labels for a previous version of the dataset and generating an actual accuracy metric based on comparing the known labels to the labeled dataset. By generating an actual accuracy metric based on comparing the second labeled dataset to the known labels of the previous version of the first dataset, the system may ensure that the best accuracy model is selected.

At step 414, process 400 (e.g., using one or more components described above) compares the first predicted accuracy metric to a threshold data labeling accuracy metric. For example, the system may compare the first predicted accuracy metric to a threshold data labeling accuracy metric. For example, the system may compare the predicted accuracy metric of a data labeling model to the threshold data labeling accuracy metric in an image processing application or natural language processing application. The comparison may help identify the data labeling model that meets the accuracy threshold and most accurately identifies desired images or parts of speech. By comparing the first predicted accuracy metric to a threshold data labeling accuracy metric, the system may identify the best accuracy data labeling model, thereby maximizing accuracy when labeling the dataset.

In some embodiments, the system may compare the predicted accuracy metric to the threshold data labeling accuracy metric by determining an attribute type, and determining the threshold data labeling accuracy metric. For example, the system may compare the first predicted accuracy metric to the threshold data labeling accuracy metric by determining an attribute type of the first set of attributes and determining the threshold data labeling accuracy metric based on the attribute type. In some embodiments, the system may select a threshold data labeling accuracy metric based on the type of attributes being processed. For example, some attributes may inherently lead to less accurate labels. Accordingly, the system may adjust the threshold data labeling accuracy metric to account for this. By comparing the predicted accuracy metric to the threshold data labeling accuracy metric by determining an attribute type, and determining the threshold data labeling accuracy metric, the system may take into consideration the attribute type which may increase the accuracy of the labels applied to the dataset by the data labeling model.

At step 416, process 400 (e.g., using one or more components described above) determines to use the first data labeling model to label the first dataset. For example, the system may in response to determining that the first predicted accuracy metric corresponds to the threshold data labeling accuracy metric, determine to use the first data labeling model to label the first dataset. For example, in an image processing application, the system may determine that the first data labeling model is the best accuracy data labeling model and label the images in the corresponding image dataset accordingly. As another example, in a natural language processing application, the system may determine that the first data labeling model is the best accuracy data labeling model and label the strings in the corresponding dataset accordingly. By determining to use the first data labeling model to label the first dataset, the system may accurately and efficiently label the dataset, regardless of the application.

At step 418, process 400 (e.g., using one or more components described above) generates for display a labeled dataset corresponding to the dataset using the data labeling model. For example, the system may generate for display, on a user interface, a first labeled dataset corresponding to the first dataset using the first data labeling model. For example, in an image processing application, the system may present to a user, a dataset of images that are labeled using the data labeling model. As another example, in a natural language processing application, the system may present to a user, a dataset of strings that are labeled using the data labeling model. By generating for display a labeled dataset corresponding to the dataset using the data labeling model, the system may allow the user to review the label and see the output of the system.

In some embodiments, the system may generate for display the labeled dataset corresponding to the dataset using the data labeling model by generating the labeled dataset, determining a current time, and assigning the labeled dataset a timestamp. For example, the system may generate for display, on a user interface, the first labeled dataset corresponding to the first dataset using the first data labeling model by generating the first labeled dataset, determining a current time, and assigning the first labeled dataset a timestamp based on the current time. In some embodiments, the system may timestamp a labeled dataset as it is generated. By doing so, the system may archive labeled data for that dataset as the dataset is continually updated.

In some embodiments, the system may generate a labeled dataset by using a second data labeling model and comparing the second labeled dataset to the labeled dataset to determine an actual accuracy metric for the data labeling model. For example, the system may generate a second labeled dataset corresponding to the first dataset using a second data labeling model, wherein the second data labeling model has a second processing rate, and wherein the second processing rate is higher than the growth rate, and comparing the second labeled dataset to the first labeled dataset to determine an actual accuracy metric for the first data labeling model. In some embodiments, the system may also label data using a model and/or algorithm that is not sublinear. The results of this model may be used to determine the accuracy of the data labeling models. For example, the system may compare the results of two models to determine a difference in accuracy. By doing so, the system may select the best accuracy data labeling model for the application and maximize the accuracy and efficiency in labeling the dataset.

In some embodiments, the system may determine an attribute type of the first set of attributes and select the first data labeling model of the plurality of data labeling models. For example, the system may determine an attribute type of the first set of attributes and select the first data labeling model of the plurality of data labeling models based on the first data labeling model corresponding to the attribute type. In some embodiments, the system may determine an attribute type for the set of attributes. The system may then determine a model that typically (or is known to) efficiently process datasets with this attribute type. By determining an attribute type of the first set of attributes and selecting the first data labeling model of the plurality of data labeling models, the system may quickly identify efficient models.

In some embodiments, the system may select the data labeling model by determining a frequency at which the first data labeling model is selected to process datasets, and comparing the frequency to a threshold frequency. For example, the system may select the first data labeling model of the plurality of data labeling models based on the first data labeling model corresponding to the attribute type by determining a frequency at which the first data labeling model is selected to process datasets with attributes having the attribute type, comparing the frequency to a threshold frequency, wherein the first data labeling model is selected from the plurality of data labeling models based on the frequency corresponding to the threshold frequency. In some embodiments, the system may maintain a library of available data labeling models. The system may periodically refresh the library by removing data models that are infrequently used. By selecting the data labeling model by determining a frequency at which the first data labeling model is selected to process datasets, and comparing the frequency to a threshold frequency, the system may ensure that the plurality of data labeling models is relevant to the application thereby increasing the efficiency of the system.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for increasing accuracy when labeling unlabeled datasets by bifurcating attribute selection and model processing, the method comprising: receiving a first dataset of unlabeled data, wherein the first dataset has a growth rate; determining, using an attribute selection model, a first set of attributes in the first dataset; determining, based on the first set of attributes, a first processing rate for a first data labeling model of a plurality of data labeling models, wherein the first processing rate is a function of a size of the first dataset; determining that the first processing rate is lower than the growth rate; selecting, based on determining that the first processing rate is lower than the growth rate, the first data labeling model from the plurality of data labeling models; determining a first predicted accuracy metric for the first data labeling model; comparing the first predicted accuracy metric to a threshold data labeling accuracy metric; in response to determining that the first predicted accuracy metric corresponds to the threshold data labeling accuracy metric, determining to use the first data labeling model to label the first dataset; and generating for display, on a user interface, a first labeled dataset corresponding to the first dataset using the first data labeling model.
2. The method of any one of the preceding embodiments, wherein determining the first set of attributes in the first dataset further comprises: determining an application type for an application using the first dataset; and filtering, based on the application type, a plurality of attributes in the first dataset to generate the first set of attributes.
3. The method of any one of the preceding embodiments, wherein determining the first set of attributes in the first dataset further comprises: determining a labeling category for the first dataset; and filtering, based on the labeling category, a plurality of attributes in the first dataset to generate the first set of attributes.
4. The method of any one of the preceding embodiments, wherein determining the first set of attributes in the first dataset further comprises: determining a size of the first dataset; and selecting, based on the size, the first attribute selection model from a plurality of attribute selection models.
5. The method of any one of the preceding embodiments, wherein determining the first set of attributes in the first dataset further comprises: determining a required processing rate of the first dataset; and selecting, based on the required processing rate, the first attribute selection model from a plurality of attribute selection models.
6. The method of any one of the preceding embodiments, wherein determining the first set of attributes in the first dataset further comprises: determining a second processing rate for the attribute selection model; determining that the second processing rate is lower than the growth rate; and selecting, based on determining that the second processing rate is lower than the growth rate, the attribute selection model.
7. The method of any one of the preceding embodiments, wherein determining the first set of attributes in the first dataset further comprises: determining a second predicted accuracy metric for the attribute selection model; comparing the second predicted accuracy metric to a threshold attribute selection accuracy metric; and in response to determining that the second predicted accuracy metric corresponds to the threshold attribute selection accuracy metric, determining to use the attribute selection model to determine the first set of attributes in the first dataset.
8. The method of any one of the preceding embodiments, wherein comparing the first predicted accuracy metric to the threshold data labeling accuracy metric further comprises: determining an attribute type of the first set of attributes; and determining the threshold data labeling accuracy metric based on the attribute type.
9. The method of any one of the preceding embodiments, wherein generating for display, on a user interface, the first labeled dataset corresponding to the first dataset using the first data labeling model further comprises: generating the first labeled dataset; determining a current time; and assigning the first labeled dataset a timestamp based on the current time.
10. The method of any one of the preceding embodiments, further comprising: generating a second labeled dataset corresponding to the first dataset using a second data labeling model, wherein the second data labeling model has a second processing rate, and wherein the second processing rate is higher than the growth rate; and comparing the second labeled dataset to the first labeled dataset to determine an actual accuracy metric for the first data labeling model.
11. The method of any one of the preceding embodiments, wherein determining the first predicted accuracy metric for the first data labeling model further comprises: retrieving a second labeled dataset, wherein the second labeled dataset corresponds to a previous version of the first dataset that labeled using the first data labeling model; comparing the second labeled dataset to known labels of the previous version of the first dataset; and generating an actual accuracy metric based on comparing the second labeled dataset to the known labels of the previous version of the first dataset, wherein the first predicted accuracy metric is based on the actual accuracy metric.
12. The method of any one of the preceding embodiments, further comprising: determining an attribute type of the first set of attributes; and selecting the first data labeling model of the plurality of data labeling models based on the first data labeling model corresponding to the attribute type.
13. The method of any one of the preceding embodiments, wherein selecting the first data labeling model of the plurality of data labeling models based on the first data labeling model corresponding to the attribute type further comprises: determining a frequency at which the first data labeling model is selected to process datasets with attributes having the attribute type; and comparing the frequency to a threshold frequency, wherein the first data labeling model is selected from the plurality of data labeling models based on the frequency corresponding to the threshold frequency.
14. A tangible, non-transitory, machine-readable medium storing instructions that, when executed by a data processing apparatus, cause the data processing apparatus to perform operations comprising those of any of embodiments 1-13.
15. A system comprising one or more processors; and memory storing instructions that, when executed by the processors, cause the processors to effectuate operations comprising those of any of embodiments 1-13.
16. A system comprising means for performing any of embodiments 1-13.

What is claimed is:

1. A system for increasing efficiency and accuracy when labeling unlabeled datasets by bifurcating attribute selection and model selection, the system comprising:
one or more processors; and
a non-transitory, computer-readable medium comprising instructions recorded thereon that when executed by one or more processors causes operation comprising:
receiving a first dataset of unlabeled data, wherein the first dataset has a plurality of attributes;
determining a growth rate for the first dataset, wherein the growth rate indicates a rate at which the first dataset is updated;
determining, using an attribute selection model, a first set of attributes from the plurality of attributes in the first dataset by filtering, based on labeling requirements for a first labeled dataset corresponding to the first dataset, the plurality of attributes;
determining, based on the first set of attributes, a first processing rate for a first data labeling model of a plurality of data labeling models, wherein the first processing rate is a function of a size of the first dataset, and wherein each data labeling model of the plurality of data labeling models is trained to label unlabeled data with one or more predetermined labels;
determining that the first processing rate is lower than the growth rate;
selecting, based on determining that the first processing rate is lower than the growth rate, the first data labeling model from the plurality of data labeling models;
determining a first predicted accuracy metric for the first data labeling model;
comparing the first predicted accuracy metric to a threshold data labeling accuracy metric;
in response to determining that the first predicted accuracy metric corresponds to the threshold data labeling accuracy metric, determining to use the first data labeling model to label the first dataset; and
generating for display, on a user interface, a first labeled dataset corresponding to the first dataset using the first data labeling model.

2. A method for increasing accuracy when labeling unlabeled datasets by bifurcating attribute selection and model processing, the method comprising:
receiving a first dataset of unlabeled data, wherein the first dataset has a growth rate;
determining, using an attribute selection model, a first set of attributes in the first dataset;
determining, based on the first set of attributes, a first processing rate for a first data labeling model of a plurality of data labeling models, wherein the first processing rate is a function of a size of the first dataset;
determining that the first processing rate is lower than the growth rate;
selecting, based on determining that the first processing rate is lower than the growth rate, the first data labeling model from the plurality of data labeling models;
determining a first predicted accuracy metric for the first data labeling model;
comparing the first predicted accuracy metric to a threshold data labeling accuracy metric;
in response to determining that the first predicted accuracy metric corresponds to the threshold data labeling accuracy metric, determining to use the first data labeling model to label the first dataset; and
generating for display, on a user interface, a first labeled dataset corresponding to the first dataset using the first data labeling model.

3. The method of claim 2, wherein determining the first set of attributes in the first dataset further comprises:
determining an application type for an application using the first dataset; and
filtering, based on the application type, a plurality of attributes in the first dataset to generate the first set of attributes.

4. The method of claim 2, wherein determining the first set of attributes in the first dataset further comprises:
determining a labeling category for the first dataset; and
filtering, based on the labeling category, a plurality of attributes in the first dataset to generate the first set of attributes.

5. The method of claim 2, wherein determining the first set of attributes in the first dataset further comprises:
determining a size of the first dataset; and
selecting, based on the size, the attribute selection model from a plurality of attribute selection models.

6. The method of claim 2, wherein determining the first set of attributes in the first dataset further comprises:
determining a required processing rate of the first dataset; and
selecting, based on the required processing rate, the attribute selection model from a plurality of attribute selection models.

7. The method of claim 2, wherein determining the first set of attributes in the first dataset further comprises:
determining a second processing rate for the attribute selection model;
determining that the second processing rate is lower than the growth rate; and
selecting, based on determining that the second processing rate is lower than the growth rate, the attribute selection model.

8. The method of claim 7, wherein determining the first set of attributes in the first dataset further comprises:
determining a second predicted accuracy metric for the attribute selection model;
comparing the second predicted accuracy metric to a threshold attribute selection accuracy metric; and
in response to determining that the second predicted accuracy metric corresponds to the threshold attribute selection accuracy metric, determining to use the attribute selection model to determine the first set of attributes in the first dataset.

9. The method of claim 2, wherein comparing the first predicted accuracy metric to the threshold data labeling accuracy metric further comprises:
determining an attribute type of the first set of attributes; and
determining the threshold data labeling accuracy metric based on the attribute type.

10. The method of claim 2, wherein generating for display, on a user interface, the first labeled dataset corresponding to the first dataset using the first data labeling model further comprises:
generating the first labeled dataset;
determining a current time; and
assigning the first labeled dataset a timestamp based on the current time.

11. The method of claim 2, further comprising:
generating a second labeled dataset corresponding to the first dataset using a second data labeling model, wherein the second data labeling model has a second processing rate, and wherein the second processing rate is higher than the growth rate; and
comparing the second labeled dataset to the first labeled dataset to determine an actual accuracy metric for the first data labeling model.

12. The method of claim 2, wherein determining the first predicted accuracy metric for the first data labeling model further comprises:
retrieving a second labeled dataset, wherein the second labeled dataset corresponds to a previous version of the first dataset that labeled using the first data labeling model;
comparing the second labeled dataset to known labels of the previous version of the first dataset; and
generating an actual accuracy metric based on comparing the second labeled dataset to the known labels of the previous version of the first dataset, wherein the first predicted accuracy metric is based on the actual accuracy metric.

13. The method of claim 2, further comprising:
determining an attribute type of the first set of attributes; and
selecting the first data labeling model of the plurality of data labeling models based on the first data labeling model corresponding to the attribute type.

14. The method of claim 13, wherein selecting the first data labeling model of the plurality of data labeling models based on the first data labeling model corresponding to the attribute type further comprises:
determining a frequency at which the first data labeling model is selected to process datasets with attributes having the attribute type; and
comparing the frequency to a threshold frequency, wherein the first data labeling model is selected from the plurality of data labeling models based on the frequency corresponding to the threshold frequency.

15. A non-transitory, computer-readable medium comprising instructions recorded thereon that when executed by one or more processors causes operations comprising:
receiving a first dataset of unlabeled data, wherein the first dataset has a growth rate;
determining, using an attribute selection model, a first set of attributes in the first dataset;
determining, based on the first set of attributes, a first processing rate for a first data labeling model of a plurality of data labeling models, wherein the first processing rate is a function of a size of the first dataset;
determining that the first processing rate is lower than the growth rate;
selecting, based on determining that the first processing rate is lower than the growth rate, the first data labeling model from the plurality of data labeling models;
determining a first predicted accuracy metric for the first data labeling model;
comparing the first predicted accuracy metric to a threshold data labeling accuracy metric;
in response to determining that the first predicted accuracy metric corresponds to the threshold data labeling accuracy metric, determining to use the first data labeling model to label the first dataset; and
generating for display, on a user interface, a first labeled dataset corresponding to the first dataset using the first data labeling model.

16. The non-transitory, computer-readable medium of claim 15, wherein determining the first set of attributes in the first dataset further comprises:
determining an application type for an application using the first dataset; and
filtering, based on the application type, a plurality of attributes in the first dataset to generate the first set of attributes.

17. The non-transitory, computer-readable medium of claim 15, wherein determining the first set of attributes in the first dataset further comprises:
determining a labeling category for the first dataset; and
filtering, based on the labeling category, a plurality of attributes in the first dataset to generate the first set of attributes.

18. The non-transitory, computer-readable medium of claim 15, wherein determining the first set of attributes in the first dataset further comprises:
determining a size of the first dataset; and
selecting, based on the size, the attribute selection model from a plurality of attribute selection models.

19. The non-transitory, computer-readable medium of claim 15, wherein determining the first set of attributes in the first dataset further comprises:
determining a required processing rate of the first dataset; and
selecting, based on the required processing rate, the attribute selection model from a plurality of attribute selection models.

20. The non-transitory, computer-readable medium of claim 15, wherein determining the first set of attributes in the first dataset further comprises:
determining a second processing rate for the attribute selection model;
determining that the second processing rate is lower than the growth rate; and
selecting, based on determining that the second processing rate is lower than the growth rate, the attribute selection model.
